(19) United States
(12) Patent Application Publication
(10) Pub. No.: US 2026/0228682 A1
(43) Pub. Date: Aug. 6, 2026

(54) SELECTIVELY MODIFIABLE MULTI-ITEM DIGITAL TAG SYSTEM

(71) Applicant: Walmart Apollo, LLC, Bentonville, AR (US)

(72) Inventors: Chris Southworth, Centerton, AR (US); Sara Livingston, Centerton, AR (US)

(21) Appl. No.: 19/042,329

(22) Filed: Jan. 31, 2025

(51) Int. Cl. G06Q 10/087; G06F 3/0482; G06F 3/0484

(52) U.S. Cl. CPC G06Q 10/087; G06F 3/0482; G06F 3/0484

(57) ABSTRACT

Examples provide a system and method for selectively modifiable multi-item digital tags for editing digital tag display data associated with one or more items without altering data displayed on the same tag for other items linked to the tag. A digital tag manager provides a multiple editing options for selecting linking new items to a digital tag, removing already linked items from the digital tag, changing item display data for one or more of the items, or replacing items linked to the tag without completing resetting the digital tag. This enables users to manage item display data quickly and easily for multiple items without having to reset the tag and manually rescan each item to recreate the linkages between the items and the digital tag. An edit interface provides a user-friendly interface enabling the users to manage linked digital tag item data faster and more efficiently.

### BACKGROUND

Digital tags, such as digital shelf labels (DSLs) and digital signs are frequently used by merchants to display product information, such as pricing, to customers. Digital tags are programmed to display product information for products which are assigned or otherwise linked to each digital tag. Some digital tags can be linked to multiple products. However, if the product information for one of the linked products requires updating or removal, the digital tag has to be reset which deletes all product associations for the tag. In such cases, the digital tag has to be manually reset to link each product back to the tag. Thus, even if only a minor price change is being made for one product linked to the tag, these current systems require a complete reset of all products linked to the tag. This is an inefficient, time-consuming, burdensome, and frustrating process for users.

### SUMMARY

Some embodiments provide a system and method for selectively modifiable multi-item digital tags. A multi-item digital tag can include a digital shelf label (DSL) or a digital sign. The multi-item digital tag is linked to a plurality of items. The multi-item digital tag includes a display screen presenting multi-item display data associated with the plurality of items linked to the multi-item digital tag. An edit interface for editing content displayed on the multi-item digital tag is presented to a user via a user interface (UI) device. The edit interface includes a plurality of edit options enabling a user to modify a first set of item data within the multi-item display data associated with a selected item in the plurality of items without altering a second set of item data within the multi-item display data associated with a second item in the plurality of items linked to the multi-item digital tag. When a selection of an edit-item option is received with a user-specified change to the first set of item data associated with the selected item, a multi-item tag manager modifies the multi-item display data in accordance with the user-specified change without altering the second item data associated with second item in the plurality of items linked to the display tag. The multi-item digital tag display screen is updated using the multi-item digital tag to reflect the user-specified change without resetting the multi-item digital tag.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for managing multi-item digital tags with greater accuracy and efficiency.

FIG. 2 is an exemplary block diagram illustrating a multi-item tag manager for managing multi-item digital tags.

FIG. 3 is an exemplary diagram of a digital tag displaying multi-item display data associated with two different items.

FIG. 4 is an exemplary diagram of a digital tag displaying multi-item display data associated with a plurality of items.

FIG. 5 is an exemplary flow chart illustrating operation of the computing device to dynamically update a digital tag using multi-item display data modified via an edit interface.

FIG. 6 is an exemplary flow chart illustrating operation of the computing device to automatically transfer an item from one digital tag to another digital tag.

FIG. 7 is an exemplary flow chart illustrating operation of the computing device to provide multi-item edit options for editing content displayed on a digital tag display.

FIG. 8 is an exemplary screenshot illustrating an edit interface having a manage digital tag option.

FIG. 9 is an exemplary screenshot illustrating an edit interface presenting a scan tag barcode instruction.

FIG. 10 is an exemplary screenshot illustrating an edit interface presenting a list of items linked to a digital tag with a refresh tag option and an edit tag option.

FIG. 11 is an exemplary screenshot illustrating a screenshot of an edit interface presenting an add-new-item option, a remove-item option, a reset option and a replace-item option.

FIG. 12 is an exemplary screenshot illustrating a confirmation page for confirming changes to multi-item digital display data.

FIG. 13 is an exemplary screenshot illustrating a system confirmation page confirming digital tag updates.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some embodiments, . . . ” For brevity and clarity of presentation, this implied leading clause is not repeated ad nauseum.

The current process of managing digital tags, such as digital shelf labels (DSLs) and digital signs, can be time-consuming and inefficient, especially when clearance items or new items need to be added or removed. A user cannot edit a DSL or digital sign once it has been created. If changes are needed, a user must re-set the digital tag and then connect it with all of the items again. This results in an inability to efficiently manage digital tags that are already associated with multiple items because a user has to start over and reset all items assigned to the digital tag every time any change, no matter how minor, is made. As a digital tag can have dozens or even hundreds of items linked to the sign, in many situations, resetting the digital tag can be an arduous, burdensome, and time-consuming task involving manually scanning each barcode on hundreds of items.

The embodiments recognize a need for a systematic way to view and edit existing items assigned to digital tags without resetting the entire digital tag and re-linking each item back to the reset digital tag. Referring to the figures, examples of the disclosure enable multi-item digital tag management. In some embodiments, a multi-item digital tag manager enables a user to quickly and easily edit contents displayed on a multi-item digital tag without resetting the digital tag. Resetting the digital tag resets the tag back to an original condition in which no items are linked to the tag. When reset, a user has to manually re-associate items to the digital tag by scanning the items or otherwise manually re-programming the digital tags to display item data for all the items. This reduces user time associated with editing and updating digital tags.

Aspects of the disclosure further enable an edit interface presented via a user interface (UI) of a user device. The edit interface enables the user to select edit options, such as, but not limited to, options to link new items to a digital tag that is already linked to at least one other item, remove an item from a digital tag without resetting the digital tag, updating some of the item data associated with one or more of the linked items without resetting the digital tag, and/or transferring a linked item from one digital tag to another digital tag. This enables improved user efficiency via the UI and improves user performance by simplifying the digital tag management process.

Other embodiments further provide for editing item data for linked items displayed on a digital tag without having to manually rescan each item and re-set the digital tag. This reduces system resource usage, such as, but not limited to, network bandwidth usage and processor usage consumed during resetting of the digital tag.

The computing device operates in an unconventional manner by enabling modification of data displayed on a multi-item digital tag, such as a DSL or digital sign, without deleting all item linkages and manually rescanning each item to re-link the items back to the digital tag. In this manner, the computing device is used in an unconventional manner and allows improved user interaction performance via the UI, faster updates to multi-item display tag data with reduced error rate, and reduced system resource usage consumed during resetting of digital tags by reducing processor load, memory usage, and network bandwidth usage, thereby improving functioning of the underlying computing device.

In some embodiments, the system provides multi-item digital tag management enabling users to remove and add items to digital tags easily, streamlining the process of updating item associations, and improving the overall user experience. An edit feature allows users to view tag/item associations, remove/add items, re-fresh the digital tag, lift and shift all associations to a new digital tag.

The edit feature, in some embodiments, allows users to view digital tag item associations, remove items, add new items, re-fresh the tag, lift and shift all item associations to a new digital shelf label, as well as modify item data associated with items. The edit feature is initiated by scanning a digital shelf label barcode or other identifier and selecting an “edit” option. The edit interface is generated and presented to the user via a UI in which all items currently linked to the tag are listed for viewing. This provides a fast and simple solution to ensure we are displaying the correct pricing and description to customers shopping our products while eliminating re-setting of digital tags by enabling users to select a digital tag and make any needed adjustments. In some embodiments, updating the digital tag display can take thirty seconds or less for edits to be completed and sent to the digital tag display for faster update of digital tag displays with reduced labor cost and increased customer satisfaction as pricing is accurate and easy to read via the digital tags.

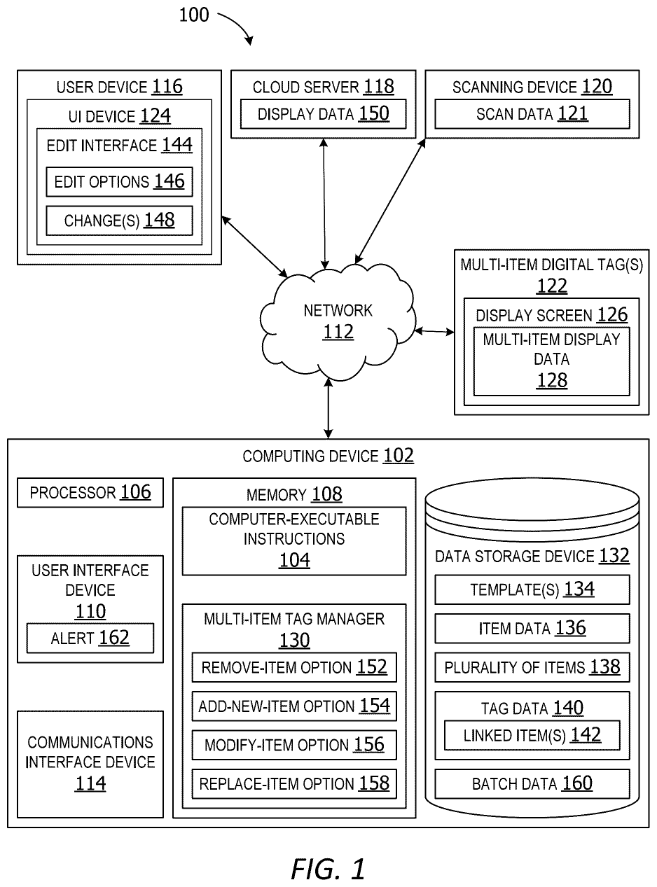

Referring again to FIG. 1, an exemplary block diagram illustrates a system 100 for managing multi-item digital tags with greater accuracy and efficiency. In the example of FIG. 1, the computing device 102 represents any device executing computer-executable instructions 104 (e.g., as application programs, operating system functionality, or both) to implement the operations and functionality associated with the computing device 102. The computing device 102, in some embodiments includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some embodiments, the computing device 102 has at least one processor 106 and a memory 108. The computing device 102, in other embodiments includes a user interface device 110.

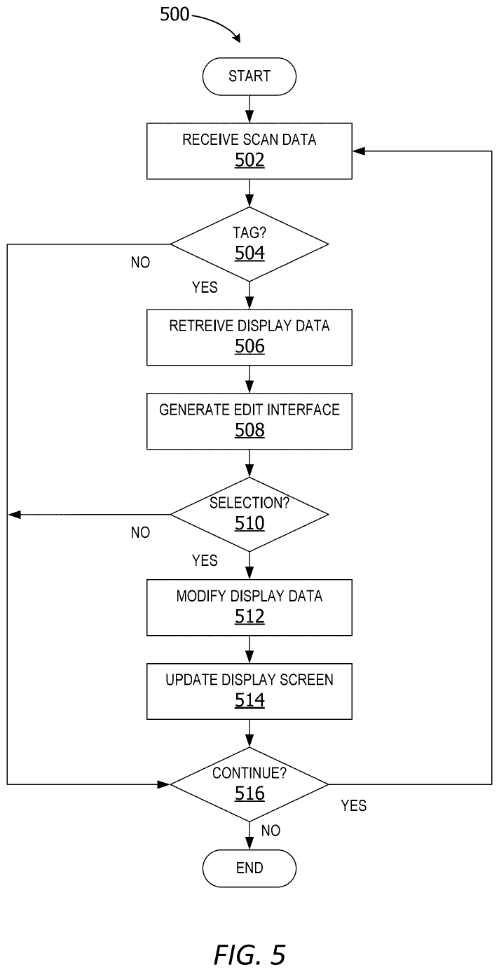

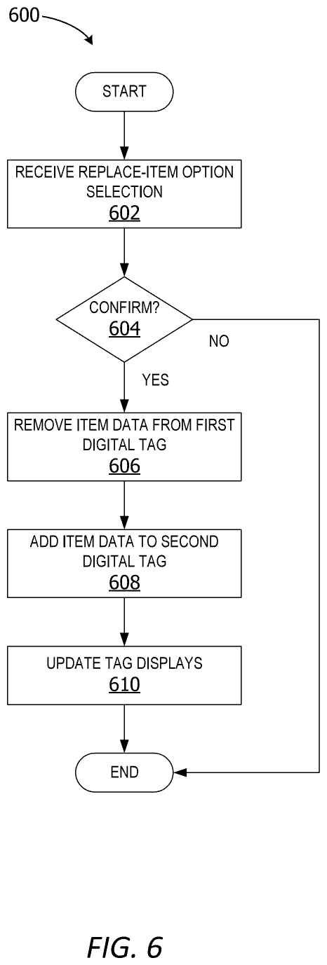

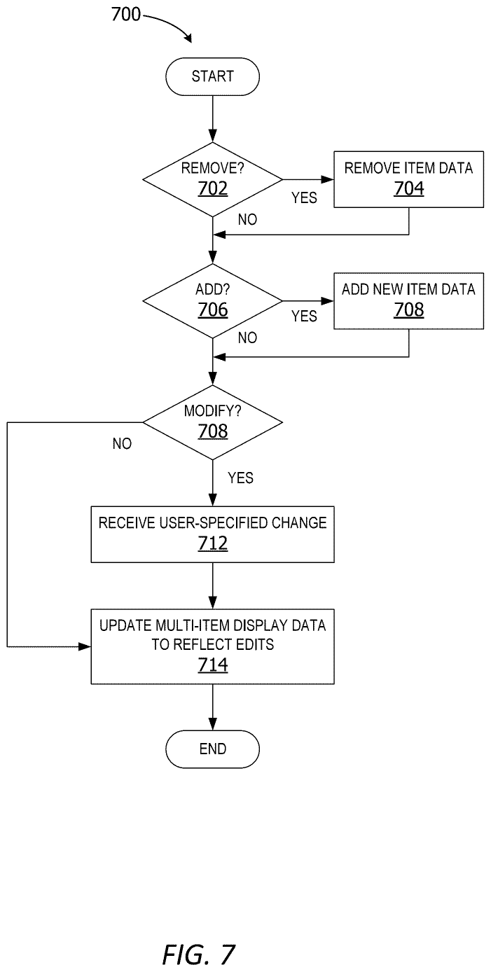

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some embodiments, the processor 106 is programmed to execute instructions such as those illustrated in the figures (e.g., FIG. 5, FIG. 6, and FIG. 7).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other embodiments, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other embodiments, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other embodiments, the network 112 is a local or private LAN.

In some embodiments, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116, a cloud server 118, a scanning device 120, and/or one or more multi-item digital tag(s) 122, can occur using any protocol or mechanism over any wired or wireless connection. In some embodiments, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI) device 124.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other embodiments, the cloud server 118 is associated with a distributed network of servers.

The scanning device 120 is a device for scanning an item identifier, a digital tag identifier, and/or a location identifier. The scanning device 120 is implemented as any type of scanning device, such as, but not limited to, a barcode scanner, a radio frequency identification (RFID) tag reader, or any other type of scanning device. The scanning device 120 reads data from an identifier, such as, but not limited to, a universal barcode (UPC), a quick response (QR) code, a digital watermark, an RFID tag, or any other type of identifier. The scan data 121 generated by the scanning device is used to identify a location of the digital tag, identify the digital tag, and/or retrieve display data for the digital tag.

The multi-item digital tag(s) 122 include one or more digital tags capable of displaying item data associated with one or more items. A multi-item digital tag can include a DSL tag, a shelf edge display device attached to a shelf edge, and/or a digital sign. A DSL tag, in some embodiments, can be attached to a shelf or other fixture. A multi-item digital tag includes a display screen 126 for displaying multi-item display data 128. In some embodiments, the multi-item display data 128 displayed on the multi-item display tag(s) 122 is received from a multi-item tag manager 130.

The system 100 can optionally include a data storage device 132 for storing data, such as, but not limited to digital tag template(s) 134, item data 136 associated with a plurality of items 138, and/or tag data 140 associated with one or more linked item(s) 142 linked to one or more of the multi-item digital tag(s) 122. A template in the template(s) 134 is a template for formatting and/or arranging data to be displayed on the display screen 126 of a digital tag.

The plurality of items 138 includes two or more items. The plurality of items can include any type of items. For example, the plurality of items can include grocery items, apparel, footwear, household goods, pet supplies, garden supplies, or any other type of items. The linked item(s) 142 includes one or more items linked to each digital tag in the multi-item digital tag(s) 122.

The data storage device 132 can include one or more different types of data storage devices, such as, for example, one or more rotating disks drives, one or more solid state drives (SSDs), and/or any other type of data storage device. The data storage device 132 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other embodiments, the data storage device 132 includes a database.

The data storage device 132 in this example is included within the computing device 102, attached to the computing device, plugged into the computing device, or otherwise associated with the computing device 102. In other embodiments, the data storage device 132 includes a remote data storage accessed by the computing device via the network 112, such as a remote data storage device, a data storage in a remote data center, or a cloud storage.

The memory 108 in some embodiments stores one or more computer-executable components, such as, but not limited to, the multi-item tag manager 130. The multi-item tag manager 130, when executed by the processor 106 of the computing device 102, generates an edit interface 144 associated with at least one multi-item digital tag via a user interface (UI) device 124. The edit interface 144 includes a plurality of edit options 146 enabling a user to modify a first set of item data within the multi-item display data 150 associated with a selected item in the plurality of items 138 without altering a second set of item data within the multi-item display data associated with a second item in the plurality of items linked to the multi-item digital tag. In this example, the multi-tag display data 128 is display data being displayed on a digital tag. The display data 150 is multi-tag display data being stored on a data storage, such as, but not limited to, a cloud storage or a data storage device.

In some embodiments, the multi-item tag manager 130 receives a selection of an edit option from the plurality of edit options and one or more user-specified change(s) 148 to the first set of item data associated with the selected item via the UI device 124. The multi-item display data 150 is updated in accordance with the user-specified change(s) 148 without altering the item data associated with other linked item(s) 142 in the plurality of items 138 linked to the display tag. The display screen 126 is updated to reflect the user-specified change(s) 148 without resetting the multi-item digital tag.

In some embodiments, the plurality of edit options 146 includes a remove-item option 152, an add-new-item option 154, a modify-item option 156, and/or a replace-item option 158. When a user selects the remove-item option 152, the multi-item tag manager 130 removes item data associated with a selected linked item from the multi-item display data 150. If a user selects an add-new-item option 154, the multi-item tag manager 130 links the new item to the multi-item digital tag and adds the item data for the new item to the multi-item display data 150. In some embodiments, this is done by updating display data 150 with the new item data. In other embodiments, the new item data is added to an existing template associated with the digital tag without resetting the digital tag.

In other embodiments, if a user selects a modify-item option 156, the system enables the user to selectively modify portions of the data in the multi-item display data 150. For example, if a user want to change the price of an item linked to a digital tag, the modify-item option 156 is used to modify the price data for the selected item without changing the rest of the item data, such as other item prices, item names, size information, item description information, etc.

In other embodiments, a replace-item option 158 enables a user to move an item linked to a first multi-item digital tag to a second multi-item digital tag. When selected, the replace-item option enables the multi-item tag manager 130 to transfer the first item data to the second multi-item digital tag. In this example, the item data for the selected item is deleted from the first multi-item digital tag and the item data for the selected item is added to the second multi-item digital tag.

In still other embodiments, the multi-item tag manager edit option(s) 146 includes a batch-update option. The multi-item tag manager 130 assigns batch data 160 associated with a batch of items to the multi-item digital tag. The multi-item tag manager 130 updates the display data 150 on the cloud server 118 to include the batch data 160. The updated multi-item display data is then transmitted from the cloud server 118 to the multi-item digital tag(s) 122 for display.

In other embodiments, the multi-item tag manager 130 saves changes made to the multi-item display data 150 on the cloud server 118 or the data storage device 132. The multi-item tag manager 130 performs an error check to check for duplicate associations. The multi-item tag manager 130 generates an alert 162 in response to detecting a duplicate association. A duplicate association refers to item data for a given item linked to two or more different digital tags.

In some embodiments, the edit feature of the system 100 enables users to view tag/item associations, remove/add items, re-fresh the tag, lift and shift all associations to a new digital shelf label. The feature is initiated by scanning a digital shelf label and selecting an “edit” option. Users can view all items currently linked to each digital tag via the UI Device 124 and/or the user interface device 110, remove selected items, and add new items by scanning barcodes or using a search function. Changes made to item associations are saved accurately, and error handling mechanisms are in place to address common issues.

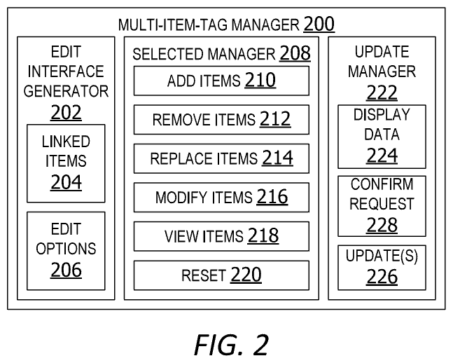

FIG. 2 is an exemplary block diagram illustrating a multi-item tag manager 200 for managing multi-item digital tags. The multi-item tag manager 200 is a component for managing multi-item digital tags, such as, but not limited to, the multi-item tag manager 130 in FIG. 1.

In some embodiments, the multi-item tag manager 200 includes an edit interface generator 202 for generating an edit interface for facilitating editing of multi-item data associated with multiple linked items 204. The multiple linked items 204 include two or more items linked to a digital tag, such as a DSL, shelf edge display, or digital sign. The edit interface includes multiple edit options 206 for editing the item data displayed on each digital tag. The edit interface generator 202 provides the edit options for editing a digital tag associated with an identifier (ID), such as, but not limited to, a location ID for an area of a retail facility in which the digital tag is assigned, a shelf ID for a shelf assigned to the digital tag, a display ID for a display associated with the digital tag, digital tag ID for the digital tag, and/or item ID associated with an item assigned to the digital tag.

A selection manager 208 manages the plurality of edit options when a user selects one or more of the edit options 206. The edit options includes options for a user to add item 210 to a tag, remove item 212 from a tag, replace item 214 with a different item or reassign the item to a different tag, modify item 216, view items 218 linked to the items, and/or reset the digital tag.

In other embodiments, an update manager updates display data 224 in accordance with selected edit options 206. The update(s) 226 are performed on the display data without resetting the digital tag, unless a user selects the reset 220 option to deliberately reset the digital tag. In this manner, the multi-item tag manager 200 adjusts the items linked to a digital shelf tag without affecting every single item linked to that tag. The multi-item tag manager 200 adjusts individual items assigned to digital shelf tags that currently have multiple items assigned to it. The multi-item tag manager 200 changes individual items assigned to multi-item tags without having to reset the entire tag and start from scratch each time they need to make a change.

In other embodiments, an update manager 222 manages update(s) 226 to the multi-item display data 224. The update manager 222 surfaces a prompt, such as a confirm request 228 requesting a user confirm requested changes to the items associated with the tag and/or change item data associated with one of the items or item types, such as a price change. An item type refers to an item which can have many instances of the item batched together with it or multiple instances of the same item linked to the same digital tag. For example, a digital tag can have thirty instances of the same blue t-shirt linked to the digital sign and forty instances of the same red t-shirt linked to the sign. In this example, we have two different types of items (red t-shirts and blue t-shirts) but we have seventy individual items linked to the sign all together.

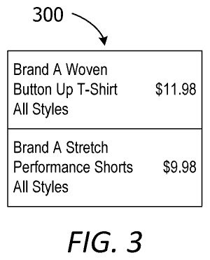

Turning now to FIG. 3, an exemplary diagram of a digital tag 300 displaying multi-item display data associated with two different items. In this example, the display screen is split into two parts in which item data for one item is displayed in one half of the display screen and item data for another item linked to the display tag is presented in the second half of the display screen.

In this example, the display screen is divided into two parts to accommodate display of item data for two different types of items. However, in other embodiments, the display screen is divided into three parts to accommodate display of item data for three different items. In still other embodiments, the display screen is divided into four parts to accommodate display of item data for four different items. In still other embodiments, the digital tag display screen presents item data for multiple items in a list or other format.

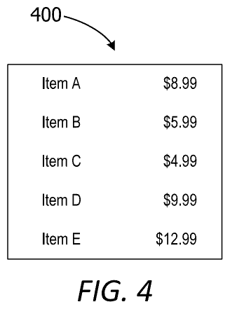

FIG. 4 is an exemplary diagram of a digital tag 400 displaying multi-item display data associated with a plurality of items. In this example, the digital tag display screen includes item data for five different types of items. However, the embodiments are not limited to five different types of items. In other embodiments, the digital tag display screen displays item data for any number of items. For example, the digital tag display screen can optionally display item data for two different items, three different items, four different items, as well as six or more different items.

FIG. 5 is an exemplary flow chart illustrating operation of the computing device to dynamically update a digital tag using multi-item display data modified via an edit interface. The process 500 shown in FIG. 5 is performed by a multi-item digital tag manager component, executing on a computing device, such as the computing device 102 or the user device 116 in FIG. 1.

The process begins by receiving scan data at 502. The scan data is data received from a scanning device scanning an identifier on a digital tag, an item, a location tag, or any other type of ID, such as, but not limited to, the scanning device 120 in FIG. 1. A determination is made whether a digital tag is recognized using the scan data at 504. If yes, display data for the digital tag is retrieved at 506. The display data is retrieved from a data storage, such as, but not limited to, a data storage device 132 in FIG. 1 and/or a cloud storage associated with a cloud server, such as, but not limited to, the cloud server 118 in FIG. 1. An edit interface is generated at 508. A determination is made whether a selection of an edit option is made at 510. If yes, the display data is modified at 512. The display screen is updated at 514. The display screen is a screen on a digital tag, such as, but not limited to, the display screen 126 in FIG. 1. A determination is made whether to continue at 516. If yes, the multi-item digital tag manager iteratively executes operations 502 through 516 until a determination is made not to continue at 516. The process terminates thereafter.

While the operations illustrated in FIG. 5 are performed by a computing device, aspects of the disclosure contemplate performance of the operations by other entities. In a non-limiting example, a cloud service performs one or more of the operations. In another embodiment, one or more computer-readable storage media storing computer-readable instructions may execute to cause at least one processor to implement the operations illustrated in FIG. 5.

FIG. 6 is an exemplary flow chart illustrating operation of the computing device to automatically transfer an item from one digital tag to another digital tag. The process 600 shown in FIG. 6 is performed by a multi-item digital tag manager component, executing on a computing device, such as the computing device 102 or the user device 116 in FIG. 1.

The process begins by receiving a replace-item option selection at 602. A determination is made whether confirmation is received at 604. If not, the process terminates thereafter. If confirmation is received, the item data for the selected item is removed from the first digital tag at 606. The item data is added to a second digital tag at 608. The tag displays for both digital tags are updated at 610. The process terminates thereafter.

While the operations illustrated in FIG. 6 are performed by a computing device, aspects of the disclosure contemplate performance of the operations by other entities. In a non-limiting example, a cloud service performs one or more of the operations. In another embodiment, one or more computer-readable storage media storing computer-readable instructions may execute to cause at least one processor to implement the operations illustrated in FIG. 6.

FIG. 7 is an exemplary flow chart illustrating operation of the computing device to provide multi-item edit options for editing content displayed on a digital tag display. The process 700 shown in FIG. 7 is performed by a multi-item digital tag manager component, executing on a computing device, such as the computing device 102 or the user device 116 in FIG. 1.

The process begins by determining whether to remove a linked item at 702. An item is removed is a user selects a remove-item option in the edit interface associated with the digital tag. If yes, the item data associated with the selected item is removed from the multi-item display data at 704. A determination is made whether to add an item to a digital tag at 706. An item is added if a user selects an edit option to add a new item to the linked items for the tag. If yes, new item data is added to the multi-item display data at 708. A determination is made whether to modify item data at 710. Item data is modified in response to a user selection of a modify-item edit option. If yes, user-specified change is received at 712. The change can include any type of change to item data, such as, but not limited to, price data, item description data, etc. The multi-item display data is updated to reflect the edits at 714. The process terminates thereafter.

While the operations illustrated in FIG. 7 are performed by a computing device, aspects of the disclosure contemplate performance of the operations by other entities. In a non-limiting example, a cloud service performs one or more of the operations. In another embodiment, one or more computer-readable storage media storing computer-readable instructions may execute to cause at least one processor to implement the operations illustrated in FIG. 7.

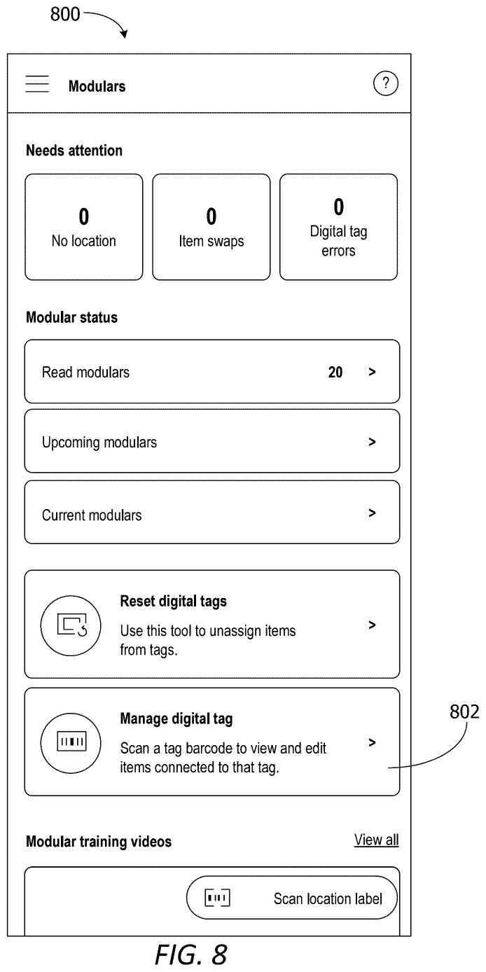

FIG. 8 is an exemplary screenshot illustrating an edit interface 800 having a manage digital tag option 802. The manage digital tag option 802 is selected to enable the user to begin editing item data associated with items linked to the digital tag. When the manage digital tag option 802 is selected, the edit interface provides a plurality of edit options for the items linked to the digital tag.

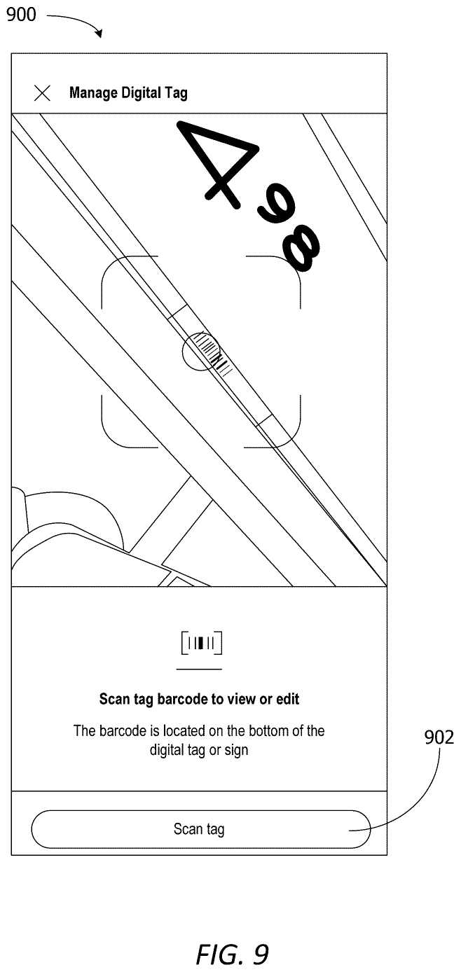

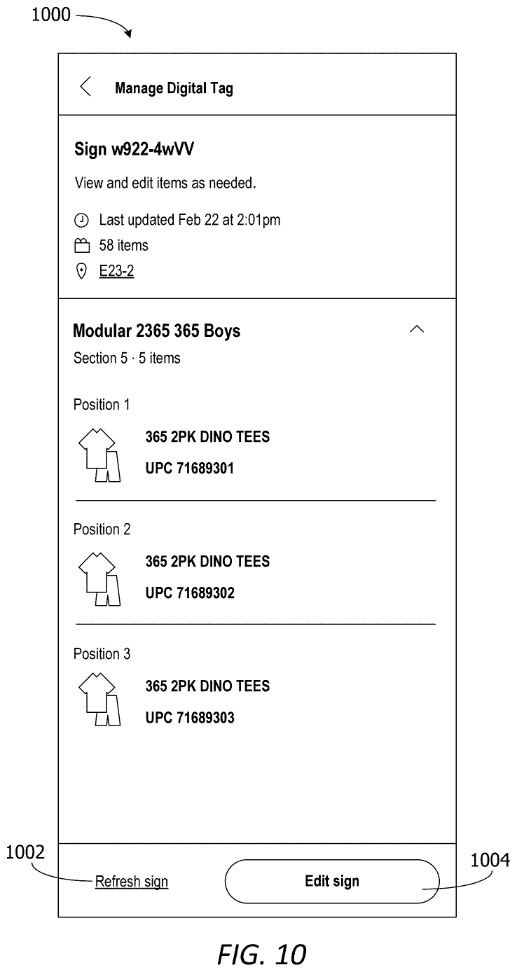

Referring now to FIG. 9, an exemplary screenshot illustrating an edit interface 900 presenting a scan tag barcode instruction 902 is shown. If a user scans a barcode associated with a modular display or a digital tag, the system uses the scan data to retrieve the multi-item display data for the plurality of items linked to the digital tag. FIG. 10 is an exemplary screenshot illustrating an edit interface 1000 presenting a list of items linked to a digital tag with a refresh tag option 1002 and an edit tag option 1004.

In this example, the edit interface instructs the user to scan a barcode or other ID tag on the multi-item digital tag device itself. However, the embodiments are not limited to scanning a barcode on a digital tag. In other embodiments, a user scans a location tag or other location marker for an area within a retail facility. In response, the system surfaces a list of all digital tags within the area. The user selects the digital tag that is being modified from the list. Once selected, the system proceeds with displaying a list of all items or item types which have been linked to the digital tag. A digital tag can have dozens or even hundreds of items linked to the digital tag.

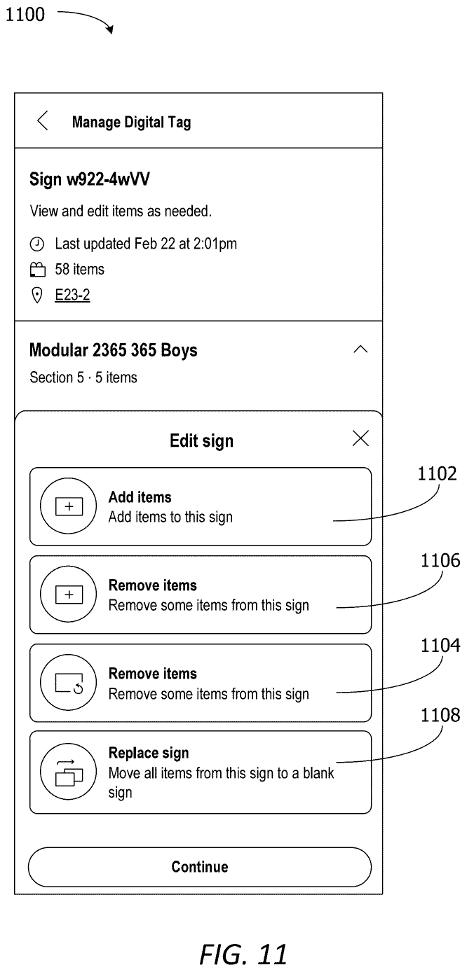

FIG. 11 is an exemplary screenshot illustrating a screenshot of an edit interface 1100 presenting an add-new-item option 1102, a remove-item option 1106, a reset option 1104 and a replace-item option 1108. When the “edit” option is selected, a user-friendly interface is be presented, allowing the user to manage item associations. The items currently linked/assigned to that digital tag are displayed. All tags can be accessed and display anything that is currently assigned to the tag, if nothing is assigned, the edit interface indicates no current items are assigned to the tag.

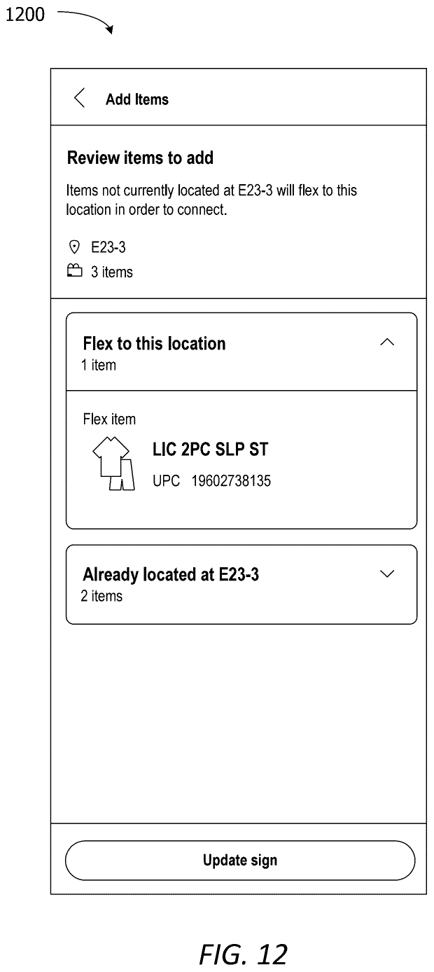

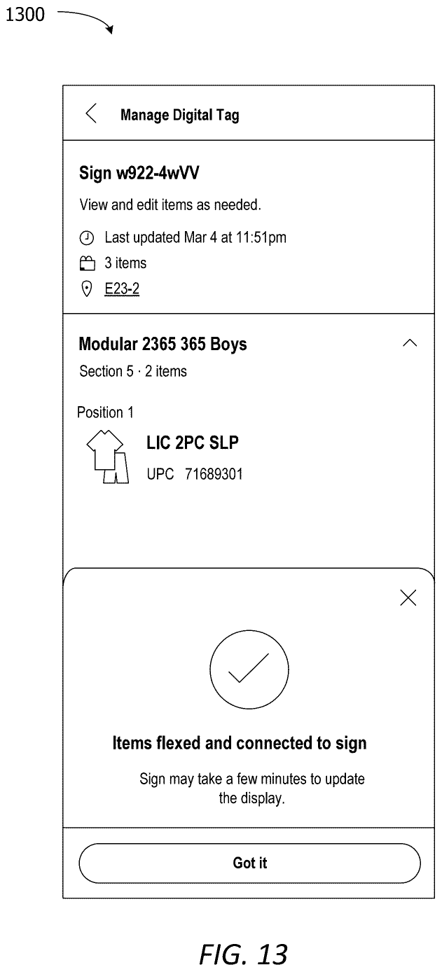

FIG. 12 is an exemplary screenshot illustrating a confirmation page 1200 for confirming changes to multi-item digital display data. FIG. 13 is an exemplary screenshot illustrating a system confirmation page 1300 confirming digital tag updates. In some embodiments, a user scans a digital tag ID. The user selects the “edit” option from the menu that appears. The edit interface is displayed, showing the items currently associated with the digital tag. The user can remove items by selecting them and confirming removal. To add new items, the user can scan their barcodes or use a search function to find and associate items with the digital tag. Prior to confirmation, users confirm their actions via a confirmation page, such as, but not limited to, the confirmation page 1200. In some embodiments, the confirmation page 1200 optionally includes a user's ID, timestamp (date action performed), and/or other data associated with the edit actions performed.

### Additional Examples

In some embodiments, a multi-item tag management system is provided that allows users to edit digital shelf labels. The system facilitates digital management of shelf tags and signs. It allows users to easily perform a range of tasks, such as adding product codes in bulk, removing items and products, refreshing and resetting tags, and moving data from one tag or sign to another. The system enhances the flexibility and efficiency of managing digital shelf labels, enabling associates to remove and add items easily, streamline the process of updating item associations, and improve the overall user experience.

In other embodiments, the system provides multi-item digital tag management. The system allows a user to scan a digital tag or barcode on the digital tag to access an edit interface for the digital tag. The system provides multiple edit options that the user can select from a menu via the edit interface to edit item data associated with linked items and/or manage item associations to the digital tag.

The system removes and/or adds items to a digital tag in response to user selection of the items linked to the digital tag without altering other already associated items for the digital tag. The user can add or remove items by scanning barcodes or using a search function. The user makes changes to information associated with one item (such as price change) linked to the digital tag that currently have multiple items assigned to it (without changing information for other items linked to the same digital tag and without having to start over or reset information for the items associated with the digital tag. The user selects a refresh option, enabling the system to take the existing template and re-push it to the tag being refreshed. When a user selects a replace option, the system takes the existing template and assigns it to a new or separate digital tag while preserving multiple item associations of the first digital tag.

In an example scenario, a user scans an ID tag associated with a location of a digital tag or an ID on the digital tag to being the editing process. When the location tag is scanned, all digital tags assigned to that location are displayed within the edit interface. The user selects a digital tag from the digital tags associated with the location. The edit interface is then populated with all the items assigned to the selected digital tag. The user can then choose various edit options for the selected digital tag and/or the items linked to the digital tag.

In some embodiments, when a user selects the “edit” option from a menu presented via a UI on a user device, the edit interface is displayed showing the items currently associated with the digital shelf label or other digital tag. The user can remove items by selecting them and confirming removal and/or add items. This enables the system to adjust the items linked to a digital shelf tag without affecting every single item linked to that tag. The user can adjust individual items assigned to digital shelf tags that currently have multiple items assigned to it. A user can initiate the editing process by scanning a digital shelf label ID, such as a barcode. After scanning, a menu with options, including “edit,” is displayed. The system enables a user to pull this feature up via the modular screen and access via the modular digital label. This enables digital management of the multi-item digital shelf labels (DSL) and multi-item digital signs via a user-friendly UI.

Some embodiments enable a user to make changes to information associated with one item linked to a multi-item digital tag, such as a price change, without changing information for other items linked to the same digital tag and without having to start over or reset (delete) information for other items associated with the digital tag. The system provides edit options for adding product codes in bulk, removing items and products, refreshing and resetting multi-item digital tags, and moving data from one tag or sign to another while preserving multiple item associations of the digital tag. Another edit feature allows users to view tag/item associations, remove/add items to a digital tag without altering other already associated items for the digital tag, re-fresh the tag, lift and shift all associations for all items on a single digital tag to a new digital tag or other digital tag.

In some embodiments, a user can scan a digital tag and view all items currently linked to the digital tag via a UI. A user can select items linked to a digital shelf label and remove them from the association. A user can scan an item to link the item to a digital shelf label that already has multiple items linked. A user can select a “refresh” option, this action takes the existing template and re-push it to the tag being refreshed. A user can select a replace-item option, which takes the existing template for a digital tag and pushes it to a new digital tag. The system creates a copy of it (all items on the original tag) while re-setting the original digital tag.

In other embodiments, a user can view all items currently linked to the tag, remove selected items, and add new items by scanning barcodes or using a search function. Changes made to item associations for a digital tag are saved accurately, and error handling mechanisms are in place to address common issues such as barcode scanning errors and duplicate associations. In some embodiments, the feature is initiated by scanning a digital shelf label and selecting an “edit” option. When the “edit” option is selected, a user-friendly interface is presented, allowing the user to manage item associations on a given multi-item digital tag.

In some embodiments, items currently linked/assigned to that digital tag is displayed. When flexing to a sign/tag identified as a multi-item sign/tag, the edit interface provides the user with the option to add to the sign instead of overriding it. This is optionally provided as an add on in the flex flow as well as in the digital tag management actions. The edit interface optionally provides a user with the ability to select multiple items by scanning their barcodes or using a search functionality. Selected items are highlighted or marked for removal or association to a new tag.

Alternatively, or in addition to the other embodiments described herein, examples include any combination of the following:
wherein the multi-item digital tag is a first multi-item digital tag, wherein the multi-item display data is first multi-item display data, wherein the edit option comprises a replace-item option, and wherein the instructions are further operative to remove the first item data from the first multi-item display data; transfer the first item data to a second multi-item digital tag; and update a second multi-item display data associated with the second multi-item digital tag to include the first item data, wherein the first multi-item digital tag displays the first multi-item display data without the first item data, wherein the first item is unlinked from the first multi-item digital tag, and wherein the second multi-item digital tag displays the second multi-item display data including the first item data representing the selected item;
wherein the edit option comprises a remove-item option, and wherein the instructions are further operative to remove first item data from the multi-item display data in response to user selection of the remove-item option for the selected item, wherein the selected item is unlinked from the multi-item digital tag without resetting the multi-item digital tag;
wherein the edit option comprises an add-new-item option, and wherein the instructions are further operative to add third item data associated with a new item to the multi-item display data in response to user selection of the add-new-item option, wherein the new item is added to the plurality of items linked to the multi-item digital tag; and update data displayed via the display screen of the display tag, wherein the updated data includes the third item data associated with the new item;
wherein the edit option comprises a modify-item option, and wherein the instructions are further operative to update the first item data without altering the second item data; and update data displayed via the display screen of the multi-item digital tag to reflect the update to the first item data;
wherein the edit option comprises a batch-update option, and wherein the instructions are further operative to assign batch data associated with a batch of items to the multi-item digital tag; and update the multi-item display data to include the batch data, wherein item data associated with a plurality of items is added, deleted, or modified in a single action;
save changes made to the multi-item display data to a data storage device; perform an error check to check for duplicate associations; and generate an alert in response to detecting a duplicate association;
receiving scan data associated with a multi-item digital tag, the scan data generated by a scanning device; retrieving multi-item display data associated with the multi-item digital tag from a data storage device using the scan data; generating an edit interface associated with the multi-item digital tag via a user interface (UI) device, the edit interface comprising a plurality of edit options enabling a user to modify a first set of item data within the multi-item display data associated with a selected item in the plurality of items without altering a second set of item data within the multi-item display data associated with a second item in the plurality of items linked to the multi-item digital tag; receiving a selection of an edit option from the plurality of edit options and a user-specified change to the first set of item data associated with the selected item; modifying the multi-item display data in accordance with the user-specified change without altering the second item data associated with second item in the plurality of items linked to the display tag; and updating a display screen associated with the multi-item digital tag to reflect the user-specified change without resetting the multi-item digital tag;
removing the first item data from the first multi-item display data; updating second multi-item display data associated with a second multi-item digital tag to include the first item data; and updating a second multi-item display data associated with the second multi-item digital tag to include the first item data, wherein the first multi-item digital tag displays the first multi-item display data without the first item data, wherein the first item is unlinked from the first multi-item digital tag, and wherein the second multi-item digital tag displays the second multi-item display data including the first item data representing the selected item;
removing first item data from the multi-item display data in response to user selection of the remove-item option for the selected item, wherein the selected item is unlinked from the multi-item digital tag without resetting the multi-item digital tag; adding third item data associated with a new item to the multi-item display data in response to user selection of the add-new-item option, wherein the new item is added to the plurality of items linked to the multi-item digital tag; and updating data displayed via the display screen of the display tag, wherein the updated data includes the third item data associated with the new item;
updating the first item data without altering the second item data; and updating data displayed via the display screen of the multi-item digital tag to reflect the update to the first item data;
assigning batch data associated with a batch of items to the multi-item digital tag; and updating the multi-item display data to include the batch data, wherein item data associated with a plurality of items is added, deleted, or modified in a single action; and
performing an error check on the multi-item display data to check for duplicate associations; and generating an alert in response to detecting a duplicate association, wherein the alert notifies a user that item data associated with a given item is populated to multiple display tags.

At least a portion of the functionality of the various elements in FIG. and FIG. 2 can be performed by other elements in FIG. 1 and FIG. 2, or an entity (e.g., processor 106, web service, server, application program, computing device, etc.) not shown in FIG. 1 and FIG. 2.

In some embodiments, the operations illustrated in FIG. 5, FIG. 6, and FIG. 7 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other embodiments, a computer readable medium having instructions recorded thereon which when executed by a computer device cause the computer device to cooperate in performing a method of selectively modifiable multi-item digital tags, the method comprising receiving scan data associated with a multi-item digital tag, the scan data generated by a scanning device; retrieving multi-item display data associated with the multi-item digital tag from a data storage device using the scan data; generating an edit interface associated with the multi-item digital tag via a user interface (UI) device, the edit interface comprising a plurality of edit options enabling a user to modify a first set of item data within the multi-item display data associated with a selected item in the plurality of items without altering a second set of item data within the multi-item display data associated with a second item in the plurality of items linked to the multi-item digital tag; receiving a selection of an edit option from the plurality of edit options and a user-specified change to the first set of item data associated with the selected item; modifying the multi-item display data in accordance with the user-specified change without altering the second item data associated with second item in the plurality of items linked to the display tag; and updating a display screen associated with the multi-item digital tag to reflect the user-specified change without resetting the multi-item digital tag.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some embodiments, to a wireless local area network using high frequency radio signals for the transmission of data. The term “BLUETOOTH®” as used herein refers, in some embodiments, to a wireless technology standard for exchanging data over short distances using short wavelength radio transmission. The term “NFC” as used herein refers, in some embodiments, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other embodiments of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for managing multi-item digital tags. For example, the elements illustrated in FIG. 1 and FIG. 2, such as when encoded to perform the operations illustrated in FIG. 5, FIG. 6, and FIG. 7, constitute exemplary means for receiving scan data associated with a multi-item digital tag, the scan data generated by a scanning device; exemplary means for identifying the multi-item digital tag via the scan data; exemplary means for retrieving multi-item display data associated with the multi-item digital tag from a data storage device; exemplary means for generating an edit interface associated with the multi-item digital tag via a user interface (UI) device, the edit interface comprising a plurality of edit options enabling a user to modify a first set of item data within the multi-item display data associated with a selected item in the plurality of items without altering a second set of item data within the multi-item display data associated with a second item in the plurality of items linked to the multi-item digital tag; exemplary means for receiving a selection of an edit option from the plurality of edit options and a user-specified change to the first set of item data associated with the selected item; exemplary means for modifying the multi-item display data in accordance with the user-specified change without altering the second item data associated with second item in the plurality of items linked to the display tag, and exemplary means for updating a display screen associated with the multi-item digital tag to reflect the user-specified change without resetting the multi-item digital tag.

Other non-limiting examples provide one or more computer storage devices having a first computer-executable instructions stored thereon for providing multi-item digital tag management. When executed by a computer, the computer performs operations including generating an edit interface associated with the multi-item digital tag via a user interface (UI) device, the edit interface comprising a plurality of edit options enabling a user to modify a first set of item data within the multi-item display data associated with a selected item in the plurality of items without altering a second set of item data within the multi-item display data associated with a second item in the plurality of items linked to the multi-item digital tag; receiving a selection of an edit option from the plurality of edit options and a user-specified change to the first set of item data associated with the selected item; modifying the multi-item display data in accordance with the user-specified change without altering the second item data associated with second item in the plurality of items linked to the display tag; and updating the display screen associated with the multi-item digital tag to reflect the user-specified change without resetting the multi-item digital tag.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” refers to the inclusion of exactly one element of a number or list of elements. In general, the term “or” as used shall only be interpreted as indicating exclusive alternatives (i.e., “one or the other but not both”) when preceded by terms of exclusivity, such as “either” “one of′ ”only one of′ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for selectively modifiable multi-item digital tags, the system comprising:
a multi-item digital tag linked to a plurality of items, the multi-item digital tag comprising a display screen presenting multi-item display data associated with the plurality of items linked to the multi-item digital tag; and
a computer-readable medium storing instructions that are operative upon execution by a processor to:
generate an edit interface associated with the multi-item digital tag via a user interface (UI) device, the edit interface comprising a plurality of edit options enabling a user to modify a first set of item data within the multi-item display data associated with a selected item in the plurality of items without altering a second set of item data within the multi-item display data associated with a second item in the plurality of items linked to the multi-item digital tag;
receive a selection of an edit option from the plurality of edit options and a user-specified change to the first set of item data associated with the selected item;
modify the multi-item display data in accordance with the user-specified change without altering the second item data associated with second item in the plurality of items linked to the display tag; and
update the display screen associated with the multi-item digital tag to reflect the user-specified change without resetting the multi-item digital tag.

2. The system of claim 1, wherein the multi-item digital tag is a first multi-item digital tag, wherein the multi-item display data is first multi-item display data, wherein the edit option comprises a replace-item option, and wherein the instructions are further operative to:
remove the first item data from the first multi-item display data;
transfer the first item data to a second multi-item digital tag; and
update a second multi-item display data associated with the second multi-item digital tag to include the first item data, wherein the first multi-item digital tag displays the first multi-item display data without the first item data, wherein the first item is unlinked from the first multi-item digital tag, and wherein the second multi-item digital tag displays the second multi-item display data including the first item data representing the selected item.

3. The system of claim 1, wherein the edit option comprises a remove-item option, and wherein the instructions are further operative to:
remove first item data from the multi-item display data in response to user selection of the remove-item option for the selected item, wherein the selected item is unlinked from the multi-item digital tag without resetting the multi-item digital tag.

4. The system of claim 1, wherein the edit option comprises an add-new-item option, and wherein the instructions are further operative to:
add third item data associated with a new item to the multi-item display data in response to user selection of the add-new-item option, wherein the new item is added to the plurality of items linked to the multi-item digital tag; and
update data displayed via the display screen of the display tag, wherein the updated data includes the third item data associated with the new item.

5. The system of claim 1, wherein the edit option comprises a modify-item option, and wherein the instructions are further operative to:
update the first item data without altering the second item data; and
update data displayed via the display screen of the multi-item digital tag to reflect the update to the first item data.

6. The system of claim 1, wherein the edit option comprises a batch-update option, and wherein the instructions are further operative to:
assign batch data associated with a batch of items to the multi-item digital tag; and
update the multi-item display data to include the batch data, wherein item data associated with a plurality of items is added, deleted, or modified in a single action.

7. The system of claim 1, wherein the instructions are further operative to:
save changes made to the multi-item display data to a data storage device;
perform an error check to check for duplicate associations; and
generate an alert in response to detecting a duplicate association.

8. A method for selectively modifiable multi-item digital tags, the method comprising:
receiving scan data associated with a multi-item digital tag, the scan data generated by a scanning device;
retrieving multi-item display data associated with the multi-item digital tag from a data storage device using the scan data;
generating an edit interface associated with the multi-item digital tag via a user interface (UI) device, the edit interface comprising a plurality of edit options enabling a user to modify a first set of item data within the multi-item display data associated with a selected item in the plurality of items without altering a second set of item data within the multi-item display data associated with a second item in the plurality of items linked to the multi-item digital tag;
receiving a selection of an edit option from the plurality of edit options and a user-specified change to the first set of item data associated with the selected item;
modifying the multi-item display data in accordance with the user-specified change without altering the second item data associated with second item in the plurality of items linked to the display tag; and
updating a display screen associated with the multi-item digital tag to reflect the user-specified change without resetting the multi-item digital tag.

9. The method of claim 8, wherein the multi-item digital tag is a first multi-item digital tag, wherein the multi-item display data is first multi-item display data, wherein the edit option comprises a replace-item option, and further comprising:
removing the first item data from the first multi-item display data;
updating second multi-item display data associated with a second multi-item digital tag to include the first item data; and
updating a second multi-item display data associated with the second multi-item digital tag to include the first item data, wherein the first multi-item digital tag displays the first multi-item display data without the first item data, wherein the first item is unlinked from the first multi-item digital tag, and wherein the second multi-item digital tag displays the second multi-item display data including the first item data representing the selected item.

10. The method of claim 8, wherein the edit option comprises a remove-item option, and further comprising:
removing first item data from the multi-item display data in response to user selection of the remove-item option for the selected item, wherein the selected item is unlinked from the multi-item digital tag without resetting the multi-item digital tag.

11. The method of claim 8, wherein the edit option comprises an add-new-item option, and further comprising:
adding third item data associated with a new item to the multi-item display data in response to user selection of the add-new-item option, wherein the new item is added to the plurality of items linked to the multi-item digital tag; and
updating data displayed via the display screen of the display tag, wherein the updated data includes the third item data associated with the new item.

12. The method of claim 8, wherein the edit option comprises a modify-item option, and further comprising:
updating the first item data without altering the second item data; and
updating data displayed via the display screen of the multi-item digital tag to reflect the update to the first item data.

13. The method of claim 8, wherein the edit option comprises a batch-update option, and further comprising:
assigning batch data associated with a batch of items to the multi-item digital tag; and
updating the multi-item display data to include the batch data, wherein item data associated with a plurality of items is added, deleted, or modified in a single action.

14. The method of claim 8, further comprising:
performing an error check on the multi-item display data to check for duplicate associations; and
generating an alert in response to detecting a duplicate association, wherein the alert notifies a user that item data associated with a given item is populated to multiple display tags.

15. One or more computer storage devices having computer-executable instructions stored thereon, which, upon execution by a computer, cause the computer to perform operations comprising:
receiving scan data associated with a multi-item digital tag, the scan data generated by a scanning device;
identifying the multi-item digital tag via the scan data;
retrieving multi-item display data associated with the multi-item digital tag from a data storage device;
generating an edit interface associated with the multi-item digital tag via a user interface (UI) device, the edit interface comprising a plurality of edit options enabling a user to modify a first set of item data within the multi-item display data associated with a selected item in the plurality of items without altering a second set of item data within the multi-item display data associated with a second item in the plurality of items linked to the multi-item digital tag;
receiving a selection of an edit option from the plurality of edit options and a user-specified change to the first set of item data associated with the selected item;
modifying the multi-item display data in accordance with the user-specified change without altering the second item data associated with second item in the plurality of items linked to the display tag; and
updating a display screen associated with the multi-item digital tag to reflect the user-specified change without resetting the multi-item digital tag.

16. The one or more computer storage devices of claim 15, wherein the multi-item digital tag is a first multi-item digital tag, wherein the multi-item display data is first multi-item display data, wherein the edit option comprises a replace-item option, and wherein the operations further comprise:
removing the first item data from the first multi-item display data;
updating second multi-item display data associated with a second multi-item digital tag to include the first item data; and
presenting, via a second display screen associated with the second multi-item digital tag, the second multi-item display data including the first item data, wherein the first multi-item digital tag displays the first multi-item display data without the first item data, wherein the first item is unlinked from the first multi-item digital tag, and wherein the second multi-item digital tag displays the second multi-item display data including the first item data representing the selected item.

17. The one or more computer storage devices of claim 15, wherein the edit option comprises a remove-item option, and wherein the operations further comprise:
removing first item data from the multi-item display data in response to user selection of the remove-item option for the selected item, wherein the selected item is unlinked from the multi-item digital tag without resetting the multi-item digital tag.

18. The one or more computer storage devices of claim 15, wherein the edit option comprises an add-new-item option, and wherein the operations further comprise:
adding third item data associated with a new item to the multi-item display data in response to user selection of the add-new-item option, wherein the new item is added to the plurality of items linked to the multi-item digital tag; and
updating data displayed via the display screen of the display tag, wherein the updated data includes the third item data associated with the new item.

19. The one or more computer storage devices of claim 15,, wherein the edit option comprises a modify-item option, and wherein the operations further comprise:
updating the first item data without altering the second item data; and
updating data displayed via the display screen of the multi-item digital tag to reflect the update to the first item data.

20. The one or more computer storage devices of claim 15, wherein the operations further comprise:
assigning batch data associated with a batch of items to the multi-item digital tag; and
updating the multi-item display data to include the batch data, wherein item data associated with a plurality of items is added, deleted, or modified in a single action.
